(19) United States
(12) Patent Application Publication
(10) Pub. No.: US 2008/0316233 A1
(43) Pub. Date: Dec. 25, 2008

(54) Computer system and method for rendering a display with a changing color frequency spectrum corresponding to a selected frequency spectrum

(76) Inventor: Bas Rokers, Austin, TX (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 12/142,614

(22) Filed: Jun. 19, 2008

Related U.S. Application Data
(60) Provisional application No. 60/944,898, filed on Jun. 19, 2007.

(51) Int. Cl. G09G 5/10; G09G 5/00

(52) U.S. Cl. 345/690; 345/204

(57) ABSTRACT

Embodiments provide methods and systems for selecting a frequency spectrum (e.g. a changing color frequency spectrum) to be emitted by a display device of a computer system and for rendering a display on the display device by emitting light corresponding to the selected (color) frequency spectrum. Other embodiments may also be described.

### CROSS REFERENCE TO RELATED APPLICATIONS

This application claims the benefit of U.S. Provisional Application No. 60/944,898, filed Jun. 19, 2007.

### TECHNICAL FIELD

Embodiments relate to the field of computer science, and in particular, to selecting a frequency spectrum and displaying a computer display having light corresponding to that particular frequency spectrum.

### BACKGROUND

Humans are sensitive to the natural properties of their environment, such as the day-night cycle and the attendant time-of-day, geographical, and seasonal changes in sunlight. There is considerable evidence that absence of these natural properties can reduce human well-being. But modern work environments do not always have these environmental properties. For example, office lighting is largely constant with a very flat color spectrum.

Light therapy is often used to overcome light-deficient disorders. It has been proven that treatments involving shining light directly towards a patient's eyes will alleviate or cure light deficient disorders such as Seasonal Affective Disorder (SAD), circadian sleep disorders, and circadian disruptions associated with jet-lag and shift-work. SAD in particular appears to be treatable to some extent by subjecting a patient to natural sunlight or to a full-spectrum lamp.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates a computer environment having a display monitor in accordance with various embodiments;

FIG. 2 illustrates a block diagram of a computer system suitable for use to practice various embodiments; and

FIG. 3 illustrates a block diagram of a frequency spectrum table in accordance with various embodiments.

### DETAILED DESCRIPTION OF EMBODIMENTS

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope of the disclosure. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent. Also, embodiments may have fewer operations than described. A description of multiple discrete operations should not be construed to imply that all operations are necessary. Also, embodiments may have fewer operations than described. A description of multiple discrete operations should not be construed to imply that all operations are necessary.

The description may use perspective-based descriptions such as up/down, back/front, and top/bottom. Such descriptions are merely used to facilitate the discussion and are not intended to restrict the application of embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments, are synonymous.

Embodiments provide a system and method for operating a computer visual display unit (i.e. a monitor or other display of a computer system) to emit a frequency spectrum corresponding to a selected frequency spectrum, such as for example the frequency spectrum of natural sunlight. In the natural world, visible color—called luminance—is a property both of the illumination (e.g. the frequency spectrum of light used to illuminate objects) as well as the portion of that light that is reflected by the objects (e.g. its reflectance). An object's reflectance does not change, but the object's luminance (e.g. color) may vary depending on the light used to illuminate it. For instance, a white object may appear red when illuminated by red-only light. Objects displayed by a display monitor mimic these two properties, but all light produced by the monitor is produced (emitted) by the monitor. A typical monitor may include many pixels, each one having a red, green, and a blue (e.g., RGB) element. Instructions sent to the monitor may separately vary the intensity with which those elements emit light, thereby producing a full range of colors. In embodiments, an emitted frequency spectrum corresponding to a selected frequency spectrum may not include all frequencies in the same ratios as the selected frequency spectrum. For example, a display having mostly dark colors may be altered to be displayed as if it were illuminated by the selected frequency spectrum—but it will not emit all colors of the selected spectrum, because that is was it means for colors to appear dark. In embodiments where the selected frequency spectrum matches or approximates natural sunlight, a display may be displayed as if it were illuminated with natural sunlight—or light approximating natural sunlight—but it may not contain all frequencies of the natural or approximated sunlight spectrum. Because the objects displayed on computer displays units do not reflect light, but instead emit light, embodiments may determine a reflectance property and an illumination property of objects displayed on the screen and alter the luminance such that the reflectance does not change but the illumination matches or mimics the selected frequency spectrum. In other words, the virtual “reflective” properties of the objects displayed by the monitor may not be altered in embodiments, but the virtual “illumination” properties of the display may be altered.

In embodiments, the selected frequency spectrum may be selected based on a time-of-day, a time-of-year, geographical considerations, or other variables. Human visual systems assume that the reflectance of objects do not change over time, and thus may assume that any changes in the luminance of objects displayed by embodiments are due to the changing time-of-day, time-of-year, or geographical factors to provide the same frequency-based cues to the user that the user would experience outdoors according to a time-of-day, time-of-year, geography, or other variance. In embodiments, a software application, operating system component, Application Programming Interface (API), display driver, or other software module may be configured to select and or generate a display having light corresponding to the selected frequency spectrum. In alternative embodiments, a hardware component such as an Application-Specific Integrated Circuit (ASIC), Field Programmable Gate Array (FPGA), graphics card, video card, or other hardware component may be configured to perform methods as described in this specification. In embodiments, a visual display unit such as a computer monitor, television, Liquid Crystal Display (LCD), plasma display unit, Cathode Ray Tube (CRT), or other display unit type may be configured to accept a video signal from a computer or other system and alter the display to emit light corresponding to the selected frequency spectrum. Embodiments are not limited by any type of types of visual display unit types.

In embodiments, a software application and/or operating system may generate a display to be displayed on the computer monitor. For example, an operating system may generate a display to be displayed having multiple application windows embedded within the overall display as in, for example, in a graphical user interface (GUI) environment. Embodiments may be configured to accept that generated display, analyze it, and alter it such that it may be displayed with the selected frequency spectrum or light corresponding to the selected frequency spectrum. Embodiments may alter the display such that the viewability or usability of the display is not impaired.

Visual Display Units may be capable of emitting full or nearly-full spectrum light, but most computing system applications do not do so because it is not necessary to render the desired display. But many computer users, such as office-workers, may use a computer for the majority of their working day and may receive little or no natural sunlight. Embodiments may allow those users to receive light from their computer monitor that matches or approximates the frequency spectrum of natural sunlight. In embodiments, this may cause the user's work environment to be non-disruptive, or less disruptive, to the user's normal day-night circadian rhythms and/or to provide light therapy to the user. Embodiments may be used, for example, to treat SAD patients. Embodiments, may allow computer users to receive light that changes throughout the day in order to mimic the changes in natural sunlight that occurs during the day. This may further enhance the effectiveness of the embodiments by more closely mimicking natural sunlight variations.

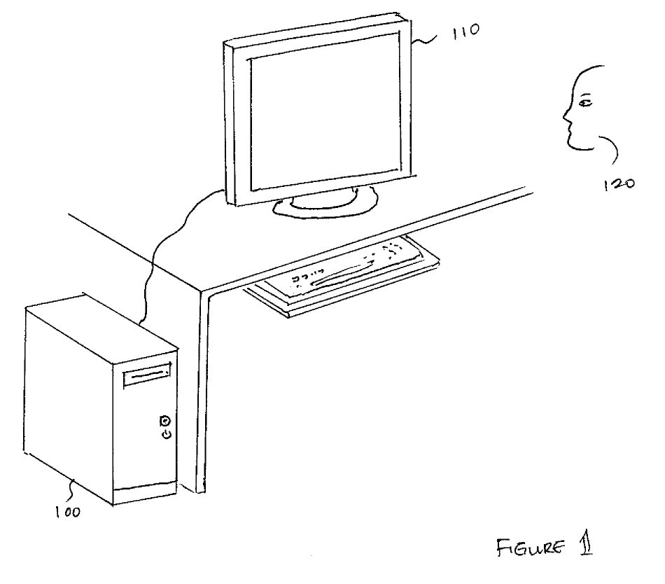

FIG. 1 illustrates a computer environment having a display monitor in accordance with various embodiments. A user 120 may be situated in front of visual display unit 110. Either computing system 100 or visual display unit 110 may select a frequency spectrum profile to display and emit a display having light that corresponds to that frequency spectrum profile. In embodiments, each successive display in the video may have a frequency spectrum that corresponds to the selected frequency spectrum profile. In embodiments, all or some of the successive display screens may be emitted with light corresponding to the selected frequency profile such that the overall effect over a period of time is to emit light with the selected frequency spectrum profile. In embodiments, screens may be altered at regular or non-regular intervals to produce the desired effect. In such embodiments, the spectral properties of the altered screens may change so gradually or sporadically that user 120 is unaware of them.

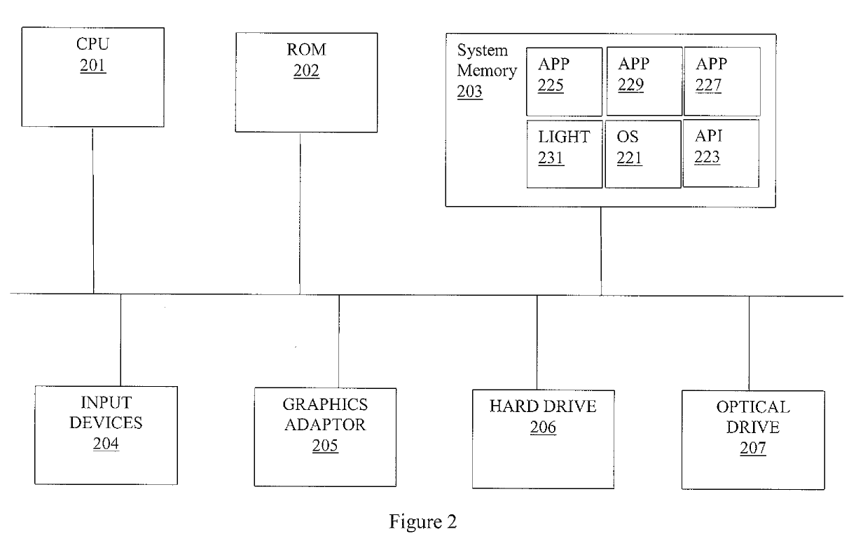

FIG. 2 illustrates a block diagram of computer system 200 suitable for use to practice various embodiments. Computer system 200 may include Central Processing Unit (CPU) 201 connected to bus or busses 209. Computer system 200 may also include Read-Only Memory (ROM) 202, system memory 203, and graphics adapter 205. Other components within or connected to computer system 200 may include input devices 204—such as a mouse, keyboard, trackball, or other—hard drive 206, and optical drive 207. Embodiments are not limited to computer systems with fewer or more components than that shown in FIG. 2.

In embodiments, graphics adapter 205 may be configured to accept video instructions from Application Programming Interface (API) 223 which may or may not be a part of Operating System (OS) 221. OS 221 and Applications 225-229 may be configured to provide video instructions representing a display to API 223, to some other component of OS 221, or directly to graphics adapter 205 using standardized or proprietary protocols.

In embodiments, light module 231 may be configured to accept, or intercept, the video instructions from applications 225-229 and/or OS 221. In embodiments, light module 231 may be configured to analyze the video instructions to determine what frequency spectrum may be emitted if displayed on a visual display unit. In embodiments, light module 231 may be configured to alter the video instructions such that the light emitted on visual display unit corresponds to a selected frequency spectrum. Light module 231 may be configured to select the selected frequency spectrum such as, for example, by performing a look-up to a table as described elsewhere within this application. Alternatively, the selected frequency spectrum may be statically-defined. In embodiments, light module 231 may be a component of OS 221 or a stand-alone software module configured to run within the execution environment of OS 221.

In embodiments, one or more of applications 225-229 may be configured to generate displays with light corresponding to the selected frequency spectrum such that subsequently altering the display is not necessary. In such embodiments, the one or more of applications 225-229 may be configured to select the frequency spectrum and generate the display corresponding to that spectrum.

In embodiments, graphics adapter 205 may be configured to perform the functions of light module 231. In such embodiments, light module 231 may be eliminated. In embodiments, graphics adapter 205 may perform some or all of the functions of light module 231 in hardware and/or software. In embodiments, graphics adapter 205 may perform a look-up to a table that resides in hard drive 206, system memory 203, or within on-board video memory within graphics adapter 205.

In embodiments, a visual display unit—not shown—may be configured to receive video display signals representing a display from graphics adapter 205. In such embodiments, the visual display unit may be configured to alter the signals upon receipt in order to cause the light emitted to correspond to the selected frequency spectrum. In other words, the signal coming from the display adapter may not produce a display having light corresponding to the selected frequency spectrum, and the visual display unit may be configured to alter it so that it does. In such embodiments, computer system 200 may be a standard computing system that produces standard video signals for display.

In embodiments—whether it is light module 331, applications 225-229, OS 221, graphics adapter 205, a visual display unit, or other component that is configured to generate a display having light corresponding to the selected frequency spectrum or to alter a previously-generated display to have such light—the display instructions may be Red-Green-Blue (RGB) values that define the intensity with which red, green, and blue pixel elements of each pixel of the visual display unit are to operate during each successive display screen. Embodiments may generate a display—such as for example a user interface display—with some or all of these RGB values altered in order to produce the desired display. In embodiments, the RGB values may be remapped. In embodiments, a common mapping function may be applied to all pixels. In other embodiments, each generated display may be analyzed and each RGB value may be independently remapped according to a different mapping variable or function. In embodiments, the collection of all pixels of each successively-rendered display screen collectively may emit light with spectral properties that corresponds to the selected spectrum.

Embodiments may achieve the desired changes in color spectrum by adjusting the color temperature of the display. This may be accomplished with light module 231, graphics adapter 205, the visual display unit, or other component of computing system 200. Color temperature can be varied along the Planckian locus in color space. Sunlight varies daily along a line very close to, but not exactly, on the Planckian locus. Thus, these embodiments may produce light that approximates—but does not exactly match—natural sunlight. Additionally, the Color Temperature may not convey the complete spectral profile of sunlight, but may approximate it with a single value. In various embodiments, such color temperature alterations may vary according to time-of-day, time-of-year, or geography, or may be unchanging.

In embodiments, not all displays may be rendered with the selected frequency spectrum. For example, if the display is of a relatively dark object, then altering that display may not cause the selected frequency spectrum to be emitted. In embodiments, limits may be placed on the alterations of the frequency spectrum. For example, a generated display containing a dark object could theoretically be altered to brighten up the dark object to match or approximate the frequency spectrum of natural sunlight. But doing so may cause the display to lose efficacy or otherwise be unusable. In embodiments, limits on the amount of alteration may therefore be employed and, accordingly, not every display screen may fully emit the selected spectrum profile. In embodiments, white pixels of a display may be more affected by alteration of the frequency spectrum than darker pixels.

Light module 231 may be executed by CPU 201 to practice or contribute to the practice of the methods described throughout the specification. This software module may be placed into hard drive 206 of computing system 200. The placement may be made in the factory, or in the field, through, for example, a distribution medium (not shown), such as a compact disc (CD), Digital Versatile Disc (DVD), or through a transceiver (from a distribution server (not shown)). In embodiments, the distribution medium may be an article of manufacture having programming instructions configured to implement one or more aspects of one or more methods as disclosed herein. More specifically, the article of manufacture may comprise a computer readable storage medium having a plurality of programming instructions stored in the storage medium. The programming instructions may then be read or loaded into a computer system to practice or contribute to the practice of the methods described herein to implement the software module(s).

In various embodiments, computer system 200 may be a server, a desktop computer, a laptop computer, a tablet computer, or a smart phone. In other embodiments, computer system 200 may be embedded in a media player, a game console, a set-top box, diskless workstation, a digital recorder, or other device.

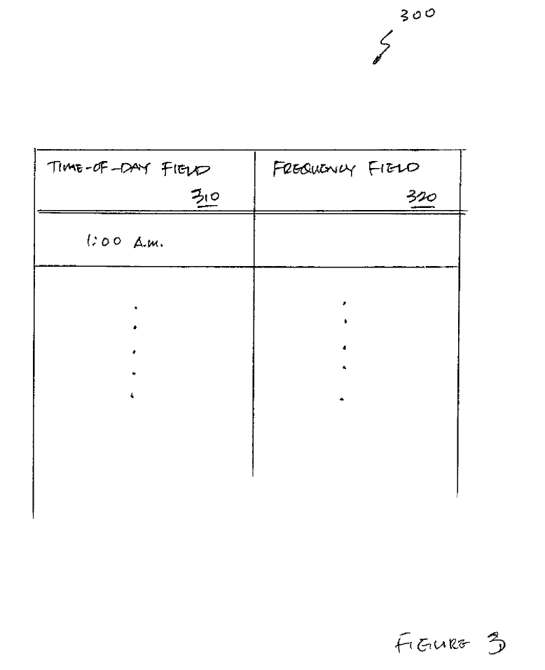

FIG. 3 illustrates a block diagram of a frequency spectrum table in accordance with various embodiments. Embodiments may vary the selected frequency spectrum according to time-of-day, time-of year, geography, or other considerations. Frequency spectrum table 300 shows a time-of-day table, but embodiments are not so limited. Time-of-day field 310 may begin at 1:00 AM or other time and may cross-reference to a particular frequency spectrum in frequency field 320. Each entry in time-of-day field 310 may be a different time of day. There may be 24 entries, each corresponding to a different hour of the day. In other embodiments, there may be more or fewer entries corresponding to shorter or longer durations than an hour. In embodiments, frequency field 320 may include a desired frequency spectrum to correspond to the displays rendered according to the time in time-of-day field 310.

In embodiments, the frequency spectrum profile contained within frequency spectrum table 300 may approximate or match the frequency spectrum profile of natural sunlight at the same time of day. For example, a 1:00 PM entry may match or approximate the frequency spectrum of natural sunlight at 1:00 PM. In embodiments, the time-of-day entries in time-of-day field 310 may be time-shifted such that the selected or desired frequency spectrum at any one time of day may not match or approximate actual sunlight at that particular time of day, but instead may be time-shifted to help the user to adjust to a schedule other than the natural day/night schedule. For example, a late-shift worker may be shown a frequency spectrum that varies on a time-of-day schedule that matches natural sunlight, but delayed by eight hours, such that his monitor renders displays matching or approximating, for example, a noon-like frequency spectrum at 8:00 PM in order to help the user stay alert longer into the day. Embodiments are not limited to any one time-shifting application, and other embodiments besides this example are contemplated.

In embodiments, the entries in frequency spectrum table 300 may be varied according to geography and/or time-of-year. That is, the frequency spectrum profile may vary to coincide with seasonal and/or geographical changes in sunlight frequency. In embodiments, the geographical and/or seasonal changes may not match the seasonal and/or geographical changes at the user's actual location but may be calculated to instead provide a user with light spectrum matching or approximating sunlight at a different geographical location and/or at a different time of year. This may be useful, for example, in treating sufferers of SAD in winter, by showing them, for example, a summer-like frequency spectrum and/or a frequency spectrum approximating that at a different geographical location.

In embodiments, frequency spectrum table 300 may reside in a visual display unit, local system storage of a computing system, a server, or other device/location. A computing system or visual display unit according to embodiments may be configured with one or more components configured to retrieve frequency spectrum table 300 from memory of the visual display unit, the computing system, or from a networked server device.

In alternative embodiments, frequency spectrum table 300 may not be used, and instead a single color temperature value may be employed at all times and for all locations.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the disclosure. Those with skill in the art will readily appreciate that embodiments of the disclosure may be implemented in a very wide variety of ways. This application is intended to cover any adaptations or variations of the embodiments discussed herein. Therefore, it is manifestly intended that embodiments of the disclosure be limited only by the claims and the equivalents thereof.

What is claimed is:

1. A method, comprising:
Selecting, by a computer system, a frequency spectrum for light emitted by a display device of the computer system to render a display on the display device; and
rendering the display on the display device by emitting light corresponding to the selected frequency spectrum.

2. The method of claim 1, wherein the selecting comprises selecting a frequency spectrum that approximates a frequency spectrum of natural sunlight when the display is rendered.

3. The method of claim 1, wherein the selecting comprises accessing a frequency spectrum profile profiling the frequency spectrum of natural sunlight over a period of time.

4. The method of claim 3, wherein the frequency spectrum profile spans a 24-hour period or 365 days.

5. The method of claim 3, wherein the accessing comprises one of: the display device accessing a storage on the display device, the display device accessing a host device of the computer system, a processor of the computing system accessing local system storage, a processor of the computing system accessing remote storage, or a processor of the computing system accessing a remote server.

6. The method of claim 1, further comprising configuring the display device to output light corresponding to the selected frequency spectrum.

7. The method of claim 6, wherein the configuring comprises a processor of the computing system configuring the display device, and wherein the selecting is performed by the processor.

8. The method of claim 1, further comprising:
generating a pre-rendered version of the display having a pre-rendered frequency spectrum different from the selected frequency spectrum; and
altering the pre-rendered version of the display to correspond to the selected frequency spectrum.

9. The method of claim 8, wherein:
the display consists of a sequence of images;
the pre-rendered frequency spectrum comprises a cumulative frequency spectrum of the sequence of images; and
the altering the pre-rendered version of the display comprises altering one or more images of the sequence of images such that the cumulative frequency spectrum corresponds to the selected frequency spectrum.

10. The method of claim 8, wherein the altering the pre-rendered version of the display comprises mapping Red-Green-Blue (RGB) values of the generated pre-rendered version of the display to new RGB values.

11. The method of claim 8, wherein the altering the pre-rendered version of the display comprises altering the color temperature.

12. The method of claim 8, further comprising determining a reflectance property and an illumination property of the pre-rendered version of the display, wherein the altering the pre-rendered version of the display further comprises altering the illumination property of the display to match or be substantially close to the selected frequency spectrum.

13. A display device, comprising:
display means configured to variably render a display and to emit light corresponding to a selected one of a plurality of frequency spectra; and
a controller coupled to the display means to control the display means.

14. The display device of claim 13, wherein the display means comprises a flat panel display, a cathode-ray-tube display, a plasma display, a thin-film transistor liquid-crystal display, or a projection display.

15. The display device of claim 13, wherein the controller controls the frequency spectrum of light emitted by the display means.

16. The display device of claim 13, wherein the controller controls the display means as instructed by a host device attached to the display device.

17. The display device of claim 13, wherein the controller is configured to select an operating frequency spectrum and to control the display means to render a display that emits light corresponding to the selected operating frequency spectrum.

18. The display device of claim 17, wherein the controller is configured to select an operating frequency spectrum that matches or approximates a frequency spectrum of natural sunlight.

19. The display device of claim 18, wherein the controller is further configured to determine the frequency spectrum of natural sunlight.

20. The display device of claim 19, wherein the controller is configured to access local system storage or a host device attached to the display device to retrieve the frequency spectrum of natural sunlight.

21. A computing system, comprising:
a processor;
a display device; and
a storage medium having a plurality of programming instructions configured to program the processor to:
select one of a plurality of spectral profiles; and
operate the display device to emit light corresponding to the selected frequency spectrum to render the display.

22. The computing system of claim 21, wherein the frequency spectrum of the emitted light matches or approximates a frequency spectrum of natural sunlight.

23. The computing system of claim 21, wherein the plurality of programming instructions are further configured to program the processor to select one of the plurality of spectral profiles based on a time-of-day or a time-of-year.

24. The computing system of claim 21, wherein the selected one of the plurality of spectral profiles approximates a frequency spectrum of natural sunlight according to a time-of-day or a time-of-year.

25. The computing system of claim 21, wherein the selected one of the plurality of spectral profiles approximates a frequency spectrum of natural sunlight according to a selected geographic region.

26. The computer system of claim 21, wherein the storage medium further comprises the plurality of spectral profiles, and wherein the plurality of programming instructions is further configured to program the processor to access the plurality of spectral profiles.

27. The computing system of claim 21, wherein the plurality of programming instructions is further configured to operate the processor to access the selected one of the plurality of spectral profiles from either a remote storage or a remote server.

28. The computing system of claim 21, wherein the plurality of programming instructions are further configured to program the processor to:
generate a pre-rendered version of the display having a pre-rendered frequency spectrum different from the selected frequency spectrum; and
altering the pre-rendered version of the display to correspond to the selected frequency spectrum according to the selected one of the plurality of spectral profiles.

29. An apparatus, comprising:
means for selecting a changing color frequency spectrum for light emitted by a display device of a computer system to render a display on the display device; and
means for rendering the display on the display device by emitting light corresponding to the selected frequency spectrum.

30. The apparatus of claim 29, wherein the means for selecting selects a frequency spectrum that approximates a frequency spectrum of natural sunlight when the display is rendered.

31. The apparatus of claim 29, wherein the means for selecting comprises means for accessing a frequency spectrum profile profiling the frequency spectrum of natural sunlight over a period of time.

32. The apparatus of claim 31, wherein the frequency spectrum profile spans a 24-hour period or 365 days.
